(19) United States
(12) Patent Application Publication
(10) Pub. No.: US 2026/0239376 A1
(43) Pub. Date: Aug. 13, 2026

(54) METHODS, DEVICES, AND COMPUTER READABLE MEDIUM FOR COMMUNICATION

(71) Applicant: NEC Corporation, Tokyo (JP)

(72) Inventors: Lin LIANG, Beijing (CN); Gang WANG, Beijing (CN)

(73) Assignee: NEC Corporation, Tokyo (JP)

(21) Appl. No.: 19/157,085

(22) PCT Filed: Feb. 16, 2023
(86) PCT No.: PCT/CN2023/076516

§ 371 Date: Aug. 15, 2025

(51) Int. Cl. H04W 72/232; H04W 72/0457; H04W 72/1273

(52) U.S. Cl. CPC H04W 72/232; H04W 72/0457; H04W 72/1273

(57) ABSTRACT

Embodiments of the present disclosure provide a solution on BWP switching. A network device transmits downlink control information to a terminal device. The downlink control information schedules a plurality of transmissions on a plurality of cells. Each cell from the plurality of cells includes one or more configured bandwidth parts (BWPs). If a value of a BWP indication in the DCI is not within a set of values configured for a cell of the plurality of cells, the terminal device ignores the BWP indication. In this way, it allows more flexibility on BWP combination for multiple cells by multiple DCI(s).

### TECHNICAL FIELD

Embodiments of the present disclosure generally relate to the field of telecommunication, and in particular, to methods, devices, and computer readable medium for bandwidth part (BWP) switching.

### BACKGROUND

Several technologies have been proposed to improve communication performances. For example, a plurality of cells may be configured. In this case, a single downlink control information (DCI) can be used to schedule transmissions on the plurality of cells. Thus, further studies on the single DCI scheduling transmissions on the plurality of cells are needed.

### SUMMARY

In general, example embodiments of the present disclosure provide a solution for BWP switching.

In a first aspect, there is provided a terminal device. The terminal device comprises a processor, configured to cause the terminal device to: receive, from a network device, downlink control information that schedules a plurality of transmissions on a plurality of cells, wherein each cell from the plurality of cells comprises one or more configured bandwidth parts (BWPs); determine, from the downlink control information, a BWP indication for the plurality of cells; and in accordance with a determination that a value of the BWP indication is not within a set of values configured for a cell of the plurality of cells, cause the BWP indication to be ignored for the cell.

In a second aspect, there is provided a terminal device. The terminal device comprises a processor, configured to cause the terminal device to: receive, from a network device, downlink control information that schedules a plurality of transmissions on a plurality of cells, wherein each cell from the plurality of cells comprises one or more configured bandwidth parts (BWPs), and wherein the plurality of cells at least comprises a first cell and a second cell; and determine, from the downlink control information, a BWP indication that indicates a target BWP which different from an active BWP for a cell, and wherein if a bitdwidth of a first field of the active BWP for the first cell is larger than a bitdwidth of the first field of the target BWP and a bitwidth of a second field of the active BWP for the second cell is smaller than a bitwidth of the second field of the target BWP for the second cell, a portion of bits of the first field of the active BWP for the first cell and bits of the second field of the active BWP for the second cell are combined to indicate the second field of the target BWP for the second cell.

In a third aspect, there is provided a terminal device. The terminal device comprises a processor, configured to cause the terminal device to: receive, from a network device, downlink control information that schedules a plurality of transmissions on a plurality of cells, wherein each cell from the plurality of cells comprises one or more configured bandwidth parts (BWPs), and wherein the plurality of cells at least comprises a first cell and a second cell; determine, from the downlink control information, a BWP indication that indicates a target BWP which different from an active BWP for a cell; and perform, for each of the plurality of cells, a bitwidth determination for the target BWP.

In a fourth aspect, there is provided a network device. The network device comprises a processor, configured to cause the network device to: transmit, to a terminal device, downlink control information that schedules a plurality of transmissions on a plurality of cells, wherein each cell from the plurality of cells comprises one or more configured bandwidth parts (BWPs), and wherein the plurality of cells at least comprises a first cell and a second cell, and wherein if a bitdwidth of a first field of the active BWP for the first cell is larger than a bitdwidth of the first field of the target BWP and a bitwidth of a second field of the active BWP for the second cell is smaller than a bitwidth of the second field of the target BWP for the second cell, a portion of bits of the first field of the active BWP for the first cell and bits of the second field of the active BWP for the second cell are combined to indicate the second field of the target BWP for the second cell.

In a fourth aspect, there is provided a method for communication. The method comprises receiving, at a terminal device and from a network device, downlink control information that schedules a plurality of transmissions on a plurality of cells, wherein each cell from the plurality of cells comprises one or more configured bandwidth parts (BWPs); determining, from the downlink control information, a BWP indication for the plurality of cells; and in accordance with a determination that a value of the BWP indication is not within a set of values configured for a cell of the plurality of cells, causing the BWP indication to be ignored for the cell.

In a fifth aspect, there is provided a method for communication. The method comprises receiving, at a terminal device and from a network device, downlink control information that schedules a plurality of transmissions on a plurality of cells, wherein each cell from the plurality of cells comprises one or more configured bandwidth parts (BWPs), and wherein the plurality of cells at least comprises a first cell and a second cell; and determining, from the downlink control information, a BWP indication that indicates a target BWP which different from an active BWP for a cell, and wherein if a bitdwidth of a first field of the active BWP for the first cell is larger than a bitdwidth of the first field of the target BWP and a bitwidth of a second field of the active BWP for the second cell is smaller than a bitwidth of the second field of the target BWP for the second cell, a portion of bits of the first field of the active BWP for the first cell and bits of the second field of the active BWP for the second cell are combined to indicate the second field of the target BWP for the second cell.

In a sixth aspect, there is provided a method for communication. The method comprises: receiving, at a terminal device from a network device, downlink control information that schedules a plurality of transmissions on a plurality of cells, wherein each cell from the plurality of cells comprises one or more configured bandwidth parts (BWPs), and wherein the plurality of cells at least comprises a first cell and a second cell; determining, from the downlink control information, a BWP indication that indicates a target BWP which different from an active BWP for a cell; and performing, for each of the plurality of cells, a bitwidth determination for the target BWP.

In a seventh aspect, there is provided a method for communication. The method comprises transmitting, at a network device and to a terminal device, downlink control information that schedules a plurality of transmissions on a plurality of cells, wherein each cell from the plurality of cells comprises one or more configured bandwidth parts (BWPs), and wherein the plurality of cells at least comprises a first cell and a second cell, and wherein if a bitdwidth of a first field of the active BWP for the first cell is larger than a bitdwidth of the first field of the target BWP and a bitwidth of a second field of the active BWP for the second cell is smaller than a bitwidth of the second field of the target BWP for the second cell, a portion of bits of the first field of the active BWP for the first cell and bits of the second field of the active BWP for the second cell are combined to indicate the second field of the target BWP for the second cell.

In an eighth aspect, there is provided a computer readable medium having instructions stored thereon, the instructions, when executed on at least one processor, causing the at least one processor to carry out the method according to the first, second, third, fourth or fifth aspect.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 is a schematic diagram of a communication environment in which embodiments of the present disclosure can be implemented;

FIG. 2 is a schematic diagram of BWP configurations according to some embodiments of the present disclosure;

FIG. 3A illustrates a signaling flow for communications according to some embodiments of the present disclosure;

FIG. 3B illustrates a signaling flow for communications according to some other embodiments of the present disclosure;

FIG. 4 illustrates a signaling flow for communications according to some embodiments of the present disclosure;

FIG. 5 is a flowchart of an example method in accordance with an embodiment of the present disclosure;

FIGS. 6A to 6D illustrate schematic diagrams of DCI for the plurality of BWPs according to some embodiments of the present disclosure, respectively;

FIG. 7 is a flowchart of an 610-example method in accordance with an embodiment of the present disclosure;

FIG. 8 is a flowchart of an example method in accordance with an embodiment of the present disclosure;

FIG. 9 is a flowchart of an example method in accordance with an embodiment of the present disclosure;

FIG. 10 is a flowchart of an example method in accordance with an embodiment of the present disclosure; and

FIG. 11 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

In some embodiments, the terminal device may be connected with a first network device and a second network device. One of the first network device and the second network device may be a master node and the other one may be a secondary node. The first network device and the second network device may use different radio access technologies (RATs). In some embodiments, the first network device may be a first RAT device and the second network device may be a second RAT device. In some embodiments, the first RAT device is eNB and the second RAT device is gNB. Information related with different RATs may be transmitted to the terminal device from at least one of the first network device or the second network device. In some embodiments, first information may be transmitted to the terminal device from the first network device and second information may be transmitted to the terminal device from the second network device directly or via the first network device. In some embodiments, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the context of the present disclosure, the term “bandwidth part (BWP)” used herein may refer to a set of attached Common Resource Blocks. A Bandwidth Part may include all Common Resource Blocks within the channel bandwidth, or a subset of Common Resource Blocks. BWP may be a part of the total channel bandwidth configured for a cell that is used for a UE at a specific moment of operation. The term “bitwidth” may refer to the number of bits of a field. The term “bitwidth” may be interchanged with the term “payload size.”

As mentioned above, further studies on the single DCI scheduling transmissions on the plurality of cells are needed. In some solutions, for DCI format 1_X, BWP indicator field may be Type 1A where field size is 0, 1 or 2 bits based on maximum size of this field in legacy formats across cells in the set configured for the DCI format 1_X, indication is applied to cell(s) having 1 or 2 bits for this field in legacy formats and indicated bit is interpreted independently for each cell based on the BWP indices for the corresponding cell. In some other solutions, for DCI format 1_X, BWP indicator field may be Type 1B where field size is dependent on number of rows in the configured table which contains combinations of indication for each cell in the set configured for the DCI format 1_X and indicated bit is interpreted as pointing one row in the configured table. In a yet solution, for DCI format 1_X, BWP indicator field may be Type 1C where field size is 0, 1 or 2 bits based on size of this field in legacy formats for one cell and indicated bit is interpreted as in legacy formats for the cell. In a further solution, for DCI format 1_X, BWP indicator field may be Type 2 where field size is sum of {0, 1, 2} bits for each cell in the set configured for the DCI format 1_X and indicated bit for each cell is interpreted as legacy formats for the cell independently. However, the function of BWP indicator for multi cell DCI (MC-DCI), especially when different cells have different number of configured BWP is not clear. Further, it is also unclear how to interpret bit field, especially when bitwidth of active BWP is different from bitwidth of indicated BWP for each cell in MC-DCI.

In order to solve at least part of the above problems or other potential problems, solutions on BWP switching are proposed. A network device transmits downlink control information to a terminal device. The downlink control information schedules a plurality of transmissions on a plurality of cells. Each cell from the plurality of cells includes one or more configured bandwidth parts (BWPs). If a value of a BWP indication in the DCI is not within a set of values configured for a cell of the plurality of cells, the terminal device ignores the BWP indication. In this way, it allows more flexibility on BWP combination for multiple cells by multiple DCI(s).

Principles and implementations of the present disclosure will be described in detail below with reference to the figures.

### Example of Communication Network

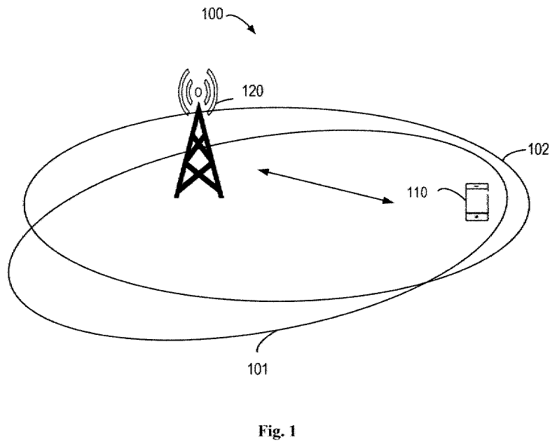

FIG. 1 illustrates a schematic diagram of an example communication network 100 in which some embodiments of the present disclosure can be implemented. As shown in FIG. 1, the communication network 100 may include a terminal device 110 and a network device 120. The network device 120 may provide a cell 101 to serve one or more terminal devices. In this example, the terminal device 110 is located in the cell 101 and is served by the network device 120. The network device 120 may also provide a cell 102 to serve one or more terminal devices. It is noted that the network device 120 may provide a proper number of cells to serve the terminal devices.

It is to be understood that the number of devices and cells in FIG. 1 is given for the purpose of illustration without suggesting any limitations to the present disclosure. The communication network 100 may include any suitable number of network devices and/or terminal devices and/or cells adapted for implementing implementations of the present disclosure.

In some embodiments, the terminal device 110 and the network device 120 may communicate with each other via a channel such as a wireless communication channel on an air interface (e.g., Uu interface). The wireless communication channel may comprise a physical uplink control channel (PUCCH), a physical uplink shared channel (PUSCH), a physical random-access channel (PRACH), a physical downlink control channel (PDCCH), a physical downlink shared channel (PDSCH) and a physical broadcast channel (PBCH). Of course, any other suitable channels are also feasible.

The communications in the communication network 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The term “slot” used herein refers to a dynamic scheduling unit. One slot comprises a predetermined number of symbols. The slot used herein may refer to a normal slot which comprises a predetermined number of symbols and also refer to a sub-slot which comprises fewer symbols than the predetermined number of symbols.

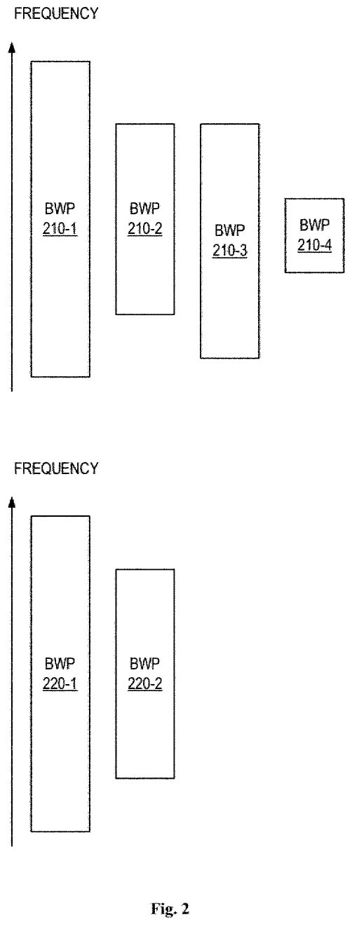

Reference is first made to FIG. 2, which is a schematic diagram of BWP configurations according to some embodiments of the present disclosure. The terminal device 110-1 can be configured with one or more BWPs. In some embodiments, the terminal device 110-1 can be configured with one or more DL BWPs. Alternatively, or in addition, the terminal device 110-1 can be configured with one or more UL BWPs. In other embodiments, the terminal device 110-1 can be configured with a common BWP or a BWP pair for both DL and UL. As shown in FIG. 2, the terminal device 110 may be configured with four BWPs 210-1, 210-2, 210-3 and 210-4 for the cell 101. The terminal device may be configured with two BWPs 220-1 and 220-2 for the cell 102. It is noted that the number of BWPs shown in FIG. 2 is only an example not limitation and one cell can be configured with any proper number of BWPs. Embodiments of the present disclosure are described with reference to FIG. 2.

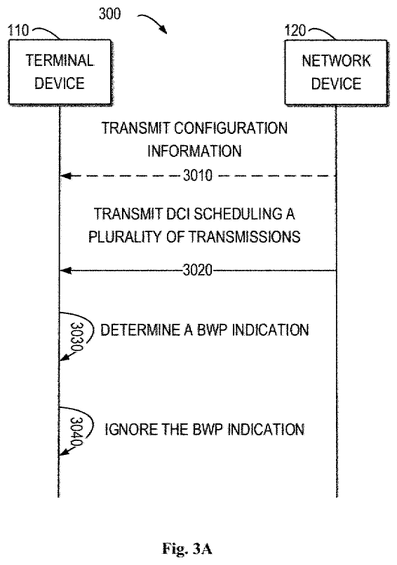

FIG. 3A shows a signaling chart illustrating process 300 among the terminal device and the network device according to some example embodiments of the present disclosure. FIG. 3B shows a signaling chart illustrating process 300 among the terminal device and the network device according to some other example embodiments of the present disclosure. Only for the purpose of discussion, the process 300 and the process 305 will be described with reference to FIG. 1. For example, the process 300 and the process 305 may involve the terminal device 110 and the network device 120.

In some example embodiments, as shown in FIG. 3A and FIG. 3B, the network device 120 may transmit (3010) configuration information indicating indexes of the one or more BWPs to the terminal device 110. For example, each BWP defined for a numerology can have following three different parameters: subcarrier spacing, symbol duration and cyclic prefix length. In some embodiments, each DL BWP may comprise at least one control resource set (CORESET) with UE Specific Search Space (USS). Alternatively, at least one of the configured DL BWPs may comprise one CORESET with common search space (CSS). With respect to uplink, the terminal device 110 may not transmit PUSCH or PUCCH outside an active bandwidth part. There may be an initial active BWP for the terminal device 110 during the initial access until the terminal device 110 is explicitly configured with BWPs during or after RRC connection establishment. The term “initial BWP” used herein can refer to a BWP which is used to perform an initial access process. The term “active BWP” used herein can refer to a UE specific/dedicated BWP. The active BWP is the BWP which the terminal device uses for data transfer when the RRC connection is established. The term “default BWP” used herein can refer to a UE specific BWP which configured during RRC reconfiguration. If the default BWP is not configured, the initial BWP can be referred as the default BWP. For example, as shown in FIG. 2, the configuration information may include configurations of the BWPs 210-1, 210-2, 210-3 and 210-4 for the cell 101. Only as an example, the BWP 210-1 can be the initial BWP, the BWP 210-2 can be the active BWP and the BWP 210-4 can be the default BWP. The configuration information may also include the configurations of the BWPs 220-1 and 220-2.

In some example embodiments, the configuration information can be transmitted via RRC signaling. Alternatively, the configuration information can be transmitted via medium access control (MAC) signaling. In other embodiments, the configuration information may be transmitted via physical layer (PHY) signaling.

The network device 120 transmits (3020) DCI scheduling a plurality of transmissions on the plurality of cells (for example, the cells 101 and 102) to the terminal device 110. In some embodiments, the DCI can be group common DCI. For example, the DCI may be in a DCI format 1/0-X, where X is an integer or a letter. In some embodiments, the plurality of transmissions may include one or more physical downlink shared channel (PDSCH) transmissions. Alternatively, or in addition, the plurality of transmissions may include one or more physical uplink shared channel (PUSCH) transmissions.

Each cell from the plurality of cells includes one or more configured BWPs. For example, as shown in FIG. 2, the cell 101 may include the BWPs 210-1, 210-2, 210-3 and 210-4. The cell 102 may include the BWPs 220-1 and 220-2.

The terminal device 110 determines (3030) a BWP indication for the plurality of cells from the DCI. For example, a BWP indicator in the DCI may indicate a BWP on each cell from the plurality of cells. By way of example, the DCI may include one or more bits in a BWP indicator field indicating a target BWP for the plurality of cells.

As shown in FIG. 3A, if a value of the BWP indication is not within a set of values configured for a cell of the plurality of cells, the terminal device 110 ignores (3040) the BWP indication for the cell. For example, the terminal device 110 may not apply the BWP indication and not perform the BWP switching for the cell. Alternatively, or in addition, the terminal device 110 may not store the BWP indication for the cell. In this way, it allows more flexibility on BWP combination for the plurality of cells by a plurality of DCIs.

In some embodiments, the set of values for the cell may be configured by a RRC signaling. For example, the set of values for the cell 101 may include 0, 1, 2 and 3. The set of values for the cell 102 may include 0 and 1. Table 1 below shows examples of UE behaviors and values of BWP indications for the cells. It is noted that Table 1 is only an example not limitations.

TABLE 1

| Value of BWP | BWP of | BWP of |
|---|---|---|
| indication | cell 102 | cell 101 |
| 0 | BWP 220-1 | BWP 210-1 |
| 1 | BWP 220-2 | BWP 210-2 |
| 2 | Ignore | BWP 210-3 |
| 3 | Ignore | BWP 210-4 |

For example, as shown in Table 1, if the value of the BWP indication in the DCI is “0”, the terminal device 110 may determine the BWP 220-1 for the cell 102 and the BWP 210-1 for the cell 101. Alternatively, if the value of the BWP indication in the DCI is “2”, the terminal device 110 may ignore the BWP indication for the cell 102, since the value “2” is out of the values configured for the cell 101 that includes 0 and 1. The terminal device 110 may also determine the BWP 210-3 for the cell 101. In this case, if more than one DCI is transmitted, the BWP combination may be achieved. By way of example, if the value of the BWP indication in the DCI is “0” and the value of the BWP indication is a subsequent DCI is “2”, the BWP combination may be the BWP 220-1 for the cell 102 and the BWP 210-3 for the cell 101. As another example, if the value of the BWP indication in the DCI is “1” and the value of the BWP indication is a subsequent DCI is “2”, the BWP combination may be the BWP 220-2 for the cell 102 and the BWP 210-3 for the cell 101.

Alternatively, as shown in FIG. 3B, the terminal device 110 performs (3140) a modulo operation using the value of the BWP indication and a BWP value for the cell. For example, the BWP indicator may be regarded as (the value of the BWP indication in DCI) mod (the BWP value for the cell). The BWP value for the cell may be configured by RRC configuration. In some embodiments, the BWP value may be equal to the number of BWPs configured for the cell excluding an initial BWP. Alternatively, the number of BWPs is equal to the BWPs configured for the cell excluding the initial BWP plus a predetermined number, for example, 1. For example, bandwidth part indicator-0, 1 or 2 bits as determined by the number of DL BWPS N_{HWP,RRC} configured by higher layers, excluding the initial DL bandwidth part. The bitwidth for this field may be determined as ┌log₂(n_{BWP})┐ bits, where n_{BWP}=n_{BWP,RRC}+1 if n_{BWP,RRC}≤3, in which case the bandwidth part indicator is equivalent to the ascending order of the higher layer parameter BWP-Id; otherwise n_{BWP}=n_{BWP,RRC}. Table 2 below shows examples of UE behaviors and values of BWP indications for the cells. It is noted that Table 2 is only an example not limitations.

TABLE 2

| Value of BWP | BWP of | BWP of |
|---|---|---|
| indication | cell 102 | cell 101 |
| 0 | BWP 220-1 | BWP 210-1 |
| 1 | BWP 220-2 | BWP 210-2 |
| 2 | BWP 220-1 | BWP 210-3 |
| 3 | BWP 220-2 | BWP 210-4 |

For example, as shown in Table 2, if the value of the BWP indication in the DCI is “0”, the terminal device 110 may determine the BWP 220-1 for the cell 102 and the BWP 210-1 for the cell 101. Alternatively, if the value of the BWP indication in the DCI is “2”, the terminal device may determine the BWP 220-1 for the cell 102 based on 2 mod 2, and the terminal device 110 may also determine the BWP 210-3 for the cell 101 based on the value of the BWP indication being “2”. By way of example, if the value of the BWP indication in the DCI is “3”, the terminal device may determine the BWP 220-2 for the cell 102 based on 3 mod 2, and the terminal device 110 may also determine the BWP 210-4 for the cell 101 based on the value of the BWP indication being “3”.

In some embodiments, the terminal device 110 may determine the number of BWP indications based on a maximum number of a BWP identity. For example, a bitwidth of BWP indicator bitwidth for that cell may be determined based on the maximum value of the higher layer parameter BWP-Id. In some cases, the terminal device 110 may determine that the BWP indication is equivalent to the value of the BWP identity, regardless of the number of BWPs configured for the cell. For example, regardless of the number of DL BWPs configured by higher layers excluding the initial DL bandwidth part, the bandwidth part indicator is equivalent to the value of the higher layer parameter BWP-Id. In this way, it allows more flexibility on BWP combination for multiple cells. Table 3 below shows examples of BWPs and values of BWP indications for the cells. It is noted that Table 3 is only an example not limitations.

TABLE 3

| BWP of | | Conventional | Enhanced |
|---|---|---|---|
| cell 102 | BWP-id | BWP indicator | BWP indicator |
| BWP 220-1 | 0 | 0 | 0 |
| BWP 220-2 | 2 | 1 | 2 |

For example, as shown in Table 3, the network device 120 may configure BWP-id of BWP 220-2 as 2. In this case, if the value of the BWP indication is “2”, the terminal device 110 may determine the BWP 220-2 for the cell 102 and the BWP 210-3 for the cell 101.

It is noted the embodiments described with reference to FIG. 3A and FIG. 3B can be implemented separately. Alternatively, embodiments described with reference to FIG. 3A and FIG. 3B can be implemented in combination.

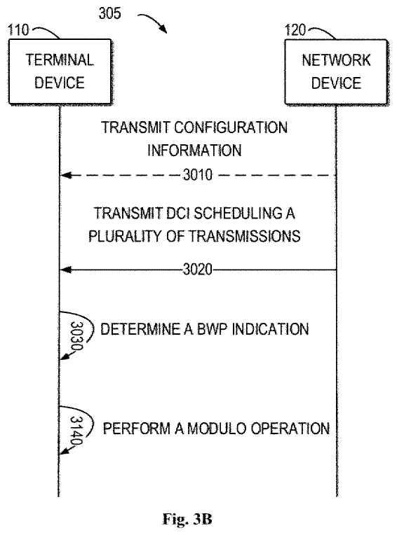

Reference is made to FIG. 4, which shows a signaling chart illustrating process 400 among the terminal device and the network device according to some example embodiments of the present disclosure. Only for the purpose of discussion, the process 400 will be described with reference to FIG. 1. For example, the process 400 may involve the terminal device 110 and the network device 120.

In some example embodiments, the network device 120 may transmit (4010) configuration information indicating indexes of the one or more BWPs to the terminal device 110. For example, each BWP defined for a numerology can have following three different parameters: subcarrier spacing, symbol duration and cyclic prefix length. In some embodiments, each DL BWP may comprise at least one control resource set (CORESET) with UE Specific Search Space (USS). Alternatively, at least one of the configured DL BWPs may comprise one CORESET with common search space (CSS). With respect to uplink, the terminal device 110 may not transmit PUSCH or PUCCH outside an active bandwidth part. There may be an initial active BWP for the terminal device 110 during the initial access until the terminal device 110 is explicitly configured with BWPs during or after RRC connection establishment. The term “initial BWP” used herein can refer to a BWP which is used to perform an initial access process. The term “active BWP” used herein can refer to a UE specific/dedicated BWP. The active BWP is the BWP which the terminal device uses for data transfer when the RRC connection is established. The term “default BWP” used herein can refer to a UE specific BWP which configured during RRC reconfiguration. If the default BWP is not configured, the initial BWP can be referred as the default BWP. For example, as shown in FIG. 2, the configuration information may include configurations of the BWPs 210-1, 210-2, 210-3 and 210-4 for the cell 101. Only as an example, the BWP 210-1 can be the initial BWP, the BWP 210-2 can be the active BWP and the BWP 210-4 can be the default BWP. The configuration information may also include the configurations of the BWPs 220-1 and 220-2.

In some example embodiments, the configuration information can be transmitted via RRC signaling. Alternatively, the configuration information can be transmitted via medium access control (MAC) signaling. In other embodiments, the configuration information may be transmitted via physical layer (PHY) signaling.

The network device 120 transmits (4020) DCI scheduling a plurality of transmissions on the plurality of cells (for example, the cells 101 and 102) to the terminal device 110. In some embodiments, the DCI can be group common DCI. For example, the DCI may be in a DCI format 1/0-X, where X is an integer or a letter. In some embodiments, the plurality of transmissions may include one or more physical downlink shared channel (PDSCH) transmissions. Alternatively, or in addition, the plurality of transmissions may include one or more physical uplink shared channel (PUSCH) transmissions.

Each cell from the plurality of cells includes one or more configured BWPs. For example, as shown in FIG. 2, the cell 101 may include the BWPs 210-1, 210-2, 210-3 and 210-4. The cell 102 may include the BWPs 220-1 and 220-2.

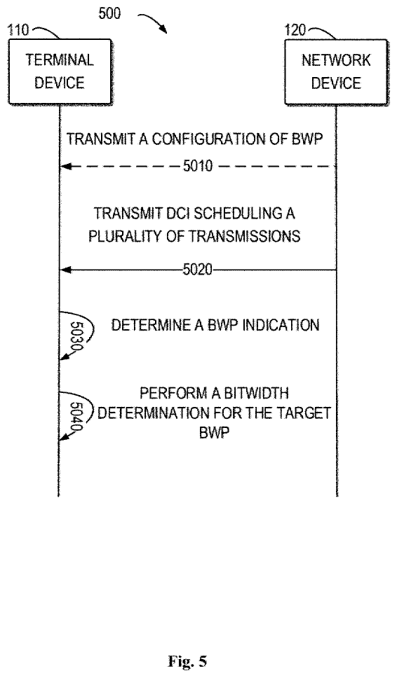

The terminal device 110 determines (4030) a BWP indication for the plurality of cells from the DCI. For example, a BWP indicator in the DCI may indicate a BWP on each cell from the plurality of cells. By way of example, the DCI may include one or more bits in a BWP indicator field indicating a target BWP for the plurality of cells. The BWP indication indicates a target BWP which is difference from an active BWP for the cell. For example, the target BWP indicated in the DCI may be different from the BWP 210-2 that is the active BWP. In this case, if a bitdwidth of a first field of the active BWP for the first cell is larger than a bitdwidth of the first field of the target BWP and a bitwidth of a second field of the active BWP for the second cell is smaller than a bitwidth of the second field of the target BWP for the second cell, a portion of bits of the first field of the active BWP for the first cell and bits of the second field of the active BWP for the second cell may be combined to indicate the second field of the target BWP for the second cell. By way of example, as shown in FIGS. 6A and 6B, the bitwidth of the field 610-1 of the active BWP for the first cell may be larger than the bitwidth of the field 620-1 of the target BWP for the first cell. The bitwidth of the field 610-2 of the active BWP for the second cell may be smaller than the bitwidth of the field 620-2 of the target BWP for the second cell. The bitwidth of the field 610-3 of the active BWP for the third cell may be larger than the bitwidth of the field 620-3 of the target BWP for the third cell. In this way, it can avoid wasting bits in the DCI, thereby improving efficiency.

In some embodiments, if the second field of the active BWP of second cell is next to the first field of the active BWP of the first cell, the portion of bits comprises least significant bits of the first field of the active BWP for the first cell. For example, as shown in FIG. 6A, the left LSB 630 of the field 610-1 of the active BWP of the first cell together with bits of the field 610-2 of the active BWP of the second cell is used to indicate the field 620-2 of the target BWP of the second cell. In this case, the most significant bits (MSBs) of the field 610-1 of the active BWP of the first cell can be used to indicate the field 620-1 of the target BWP of the first cell.

Alternatively, if the second field of the active BWP of second cell is before the first field of the active BWP of the first cell, the portion of bits comprises least significant bits of the first field of the active BWP for the first cell. For example, as shown in FIG. 6B, the MSB 640 of the field 610-3 of the active BWP together with bits of the field 610-2 of the active BWP of the second cell is used to indicate the field 620-2 of the target BWP of the second cell. In this case, the left LSBs of the field 610-3 of the active BWP of the third cell can be used to indicate the field 620-3 of the target BWP of the third cell.

In some other embodiments, if a bitwidth of a third field of the active BWP for a third cell is larger than a bitwidth of the third field of the target BWP of the third cell, the combination of the portion of bits of the first field of the active BWP for the first cell and the bits of the second field of the active BWP for the second cell is smaller than the bitwidth of the second field of the target BWP for the second cell, a portion of bits of the third field of the active BWP for the third cell is also used to indicate the second field of the target BWP for the second cell. In this case, in some embodiments, the portion of bits of the third field of the active BWP for the third cell comprises most significant bits of the third fields of the active BWP for the third cell. For example, if the bitwidth used to indicate after procedures in FIG. 6B of a second cell before to the third cell is smaller than the bitwidth of the field of the indicated bandwidth part of the second cell, then, bitwidth of the field of the indicated bandwidth part of the third cell LSB is used to indicate the field of the indicated bandwidth part of the third cell and the left MSB of field of the active bandwidth part of the third cell together with bits used to indicate after procedures in FIG. 6B of a second cell is used to indicate the field of the indicated bandwidth part of the second cell. By way of example, as shown in FIG. 6C, the LSB 630 of the field 610-1, the bits of the field 610-2 and the MSB 640 of the field 610-3 may be combined to indicate the field 620-2.

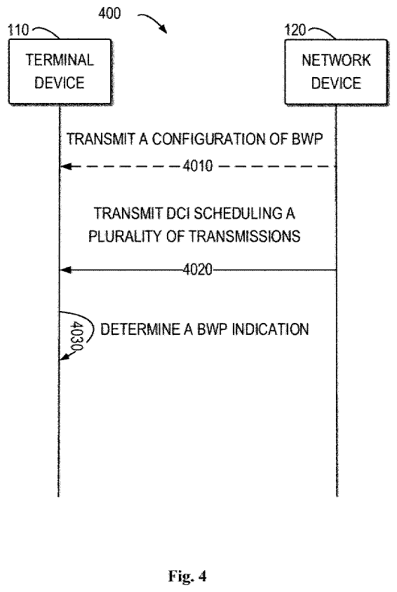

Reference is made to FIG. 5, which shows a signaling chart illustrating process 500 among the terminal device and the network device according to some example embodiments of the present disclosure. Only for the purpose of discussion, the process 500 will be described with reference to FIG. 1. For example, the process 500 may involve the terminal device 110 and the network device 120.

In some example embodiments, the network device 120 may transmit (5010) configuration information indicating indexes of the one or more BWPs to the terminal device 110. For example, each BWP defined for a numerology can have following three different parameters: subcarrier spacing, symbol duration and cyclic prefix length. In some embodiments, each DL BWP may comprise at least one control resource set (CORESET) with UE Specific Search Space (USS). Alternatively, at least one of the configured DL BWPs may comprise one CORESET with common search space (CSS). With respect to uplink, the terminal device 110 may not transmit PUSCH or PUCCH outside an active bandwidth part. There may be an initial active BWP for the terminal device 110 during the initial access until the terminal device 110 is explicitly configured with BWPs during or after RRC connection establishment. The term “initial BWP” used herein can refer to a BWP which is used to perform an initial access process. The term “active BWP” used herein can refer to a UE specific/dedicated BWP. The active BWP is the BWP which the terminal device uses for data transfer when the RRC connection is established. The term “default BWP” used herein can refer to a UE specific BWP which configured during RRC reconfiguration. If the default BWP is not configured, the initial BWP can be referred as the default BWP. For example, as shown in FIG. 2, the configuration information may include configurations of the BWPs 210-1, 210-2, 210-3 and 210-4 for the cell 101. Only as an example, the BWP 210-1 can be the initial BWP, the BWP 210-2 can be the active BWP and the BWP 210-4 can be the default BWP. The configuration information may also include the configurations of the BWPs 220-1 and 220-2.

In some example embodiments, the configuration information can be transmitted via RRC signaling. Alternatively, the configuration information can be transmitted via medium access control (MAC) signaling. In other embodiments, the configuration information may be transmitted via physical layer (PHY) signaling.

The network device 120 transmits (5020) DCI scheduling a plurality of transmissions on the plurality of cells (for example, the cells 101 and 102) to the terminal device 110. In some embodiments, the DCI can be group common DCI. For example, the DCI may be in a DCI format 1/0-X, where X is an integer or a letter. In some embodiments, the plurality of transmissions may include one or more physical downlink shared channel (PDSCH) transmissions. Alternatively, or in addition, the plurality of transmissions may include one or more physical uplink shared channel (PUSCH) transmissions.

Each cell from the plurality of cells includes one or more configured BWPs. For example, as shown in FIG. 2, the cell 101 may include the BWPs 210-1, 210-2, 210-3 and 210-4. The cell 102 may include the BWPs 220-1 and 220-2.

The terminal device 110 determines (5030) a BWP indication from the DCI. The BWP indication indicates a target BWP which different from an active BWP for a cell. The terminal device 110 perform (5040), for each of the plurality of cells, a bitwidth determination for the target BWP. For example, as shown in FIG. 6D, the terminal device 110 may separately determine the bitwidths of the field 620-1 for the first cell, the field 620-2 for the second cell, or the 620-3 for the third cell. In this way, it has least impact on implementations, and it is easy to achieve.

In some embodiments, if a bitwidth of the field of the active BWP of a target cell is smaller than the bitwidth of the field a target BWP of the target cell, the terminal device 110 may apply a predetermined resource allocation type for the target BWP of the target cell. For example, if resourceAllocation is configured as ‘dynamicSwitch’ for the target BWP of the cell, the terminal device 110 may assume resource allocation type 0 for the target BWP of the cell, if the bitwidth of the “Frequency domain resource assignment” field of the active BWP of the same cell is smaller than the bitwidth of the “Frequency domain resource assignment” field of the target BWP of the cell.

Alternatively, or in addition, if a value of codeword number for the target BWP of a target cell is larger than a value of codeword number for the active BWP of the target cell, the terminal device 110 may ignore a part of decoding information for the target BWP of the target cell. For example, the value of maxNrofCodeWordsScheduledByDCI for the target BWP of a cell equals to 2 and the value of maxNrofCodeWordsScheduledByDCI for the active BWP of the same cell equals to 1, the terminal device 110 may assume that zeros are padded when interpreting the “Modulation and coding scheme”, “New data indicator”, and “Redundancy version” fields of transport block 2. The terminal device 110 may ignore the “Modulation and coding scheme”, “New data indicator”, and “Redundancy version” fields of transport block 2 for the target BWP of the cell.

It is noted that embodiments described with reference to FIGS. 2-5 can be implemented in any combinations. Alternatively, embodiments described with reference to FIGS. 2-5 can be implemented separately. The present disclosure is not limited in this aspect.

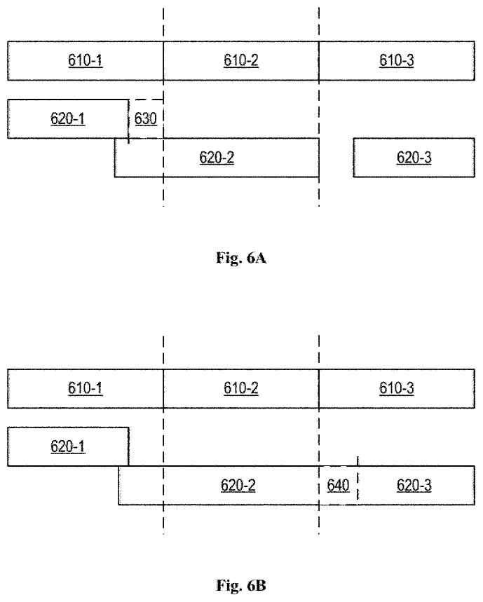

FIG. 7 shows a flowchart of an example method 700 in accordance with an embodiment of the present disclosure. The method 700 can be implemented at any suitable terminal devices. Only for the purpose of illustrations, the method 700 can be implemented at a terminal device 110 as shown in FIG. 1.

At block 710, the terminal device 110 receives, from the network device 120, downlink control information that schedules a plurality of transmissions on a plurality of cells. Each cell from the plurality of cells comprises one or more configured bandwidth parts (BWPs).

At block 720, the terminal device 110 determines, from the downlink control information, a BWP indication for the plurality of cells. At block 730, if a value of the BWP indication is not within a set of values configured for a cell of the plurality of cells, the terminal device 110 causes the BWP indication to be ignored for the cell.

In some embodiments, the terminal device 110 may not apply the BWP indication. In this case, the terminal device 110 may not switch to the BWP.

In some embodiments, the terminal device 110 may perform a modulo operation using the value of the BWP indication and a BWP value for the cell. In this case, in some embodiments, the BWP value is equal to the number of BWPs configured for the cell excluding an initial BWP. Alternatively, the BWP value is equal to the number of BWPs configured for the cell excluding an initial BWP plus 1.

In some embodiments, the terminal device 110 may determine a bitwidth of the BWP indication based on a maximum value of a BWP identity. In some embodiments, regardless of the number of BWPs configured for the cell, the terminal device 110 may determine that the value of the BWP indication is equivalent to the value of the BWP identity.

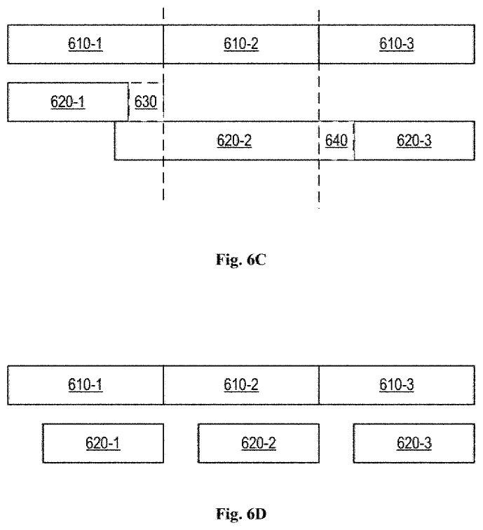

FIG. 8 shows a flowchart of an example method 800 in accordance with an embodiment of the present disclosure. The method 800 can be implemented at any suitable terminal devices. Only for the purpose of illustrations, the method 800 can be implemented at a terminal device 110 as shown in FIG. 1.

At block 810, the terminal device 110 receives, from the network device 120, downlink control information that schedules a plurality of transmissions on a plurality of cells. Each cell from the plurality of cells comprises one or more configured bandwidth parts (BWPs). The plurality of cells at least comprises a first cell and a second cell.

At block 820, the terminal device 110 determines, from the downlink control information, a BWP indication that indicates a target BWP which different from an active BWP for a cell. If a bitdwidth of a first field of the active BWP for the first cell is larger than a bitdwidth of the first field of the target BWP and a bitwidth of a second field of the active BWP for the second cell is smaller than a bitwidth of the second field of the target BWP for the second cell, a portion of bits of the first field of the active BWP for the first cell and bits of the second field of the active BWP for the second cell are combined to indicate the second field of the target BWP for the second cell.

In some embodiments, if the second field of the active BWP of second cell is next to the first field of the active BWP of the first cell, the portion of bits comprises least significant bits of the first field of the active BWP for the first cell. In some embodiments, if the second field of the active BWP of second cell is before the first field of the active BWP of the first cell, the portion of bits comprises most significant bits of the first field of the active BWP for the first cell.

In some embodiments, the plurality of cells also comprises a third cell. In this case, in some embodiments, if a bitwidth of a third field of the active BWP for a third cell is larger than a bitwidth of the third field of the target BWP of the third cell, the combination of the portion of bits of the first field of the active BWP for the first cell and the bits of the second field of the active BWP for the second cell is smaller than the bitwidth of the second field of the target BWP for the second cell, a portion of bits of the third field of the active BWP for the third cell is also used to indicate the second field of the target BWP for the second cell.

In some embodiments, the portion of bits of the third field of the active BWP for the third cell comprises most significant bits of the third fields of the active BWP for the third cell.

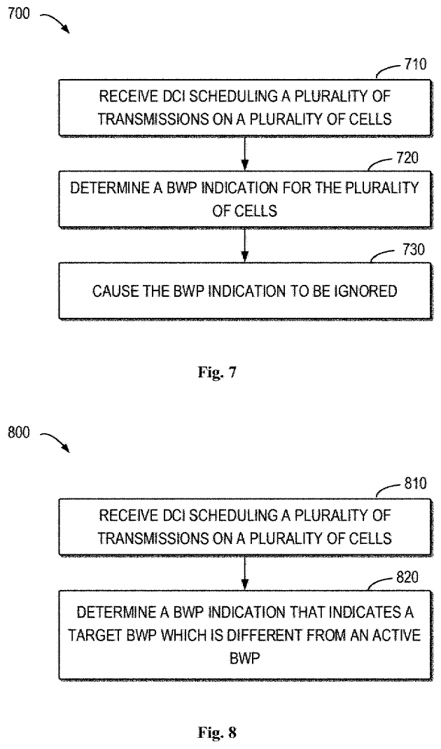

FIG. 9 shows a flowchart of an example method 9000 in accordance with an embodiment of the present disclosure. The method 900 can be implemented at any suitable terminal devices. Only for the purpose of illustrations, the method 900 can be implemented at a terminal device 110 as shown in FIG. 1.

At block 910, the terminal device 110 receives, from a network device, downlink control information that schedules a plurality of transmissions on a plurality of cells. Each cell from the plurality of cells comprises one or more configured bandwidth parts (BWPs). The plurality of cells at least comprises a first cell and a second cell.

At block 920, the terminal device 110 determines, from the downlink control information, a BWP indication that indicates a target BWP which different from an active BWP for a cell. At block 930, the terminal device 110 performs, for each of the plurality of cells, a bitwidth determination for the target BWP.

In some embodiments, if a bitwidth of the field of the active BWP of a target cell is smaller than the bitwidth of the field the a target BWP of the target cell, the terminal device 110 apply a predetermined resource allocation type for the target BWP of the target cell. Alternatively, or in addition, if a value of codeword number for the target BWP of a target cell is larger than a value of codeword number for the active BWP of the target cell, the terminal device 110 may cause a part of decoding information for the target BWP of the target cell to be ignored.

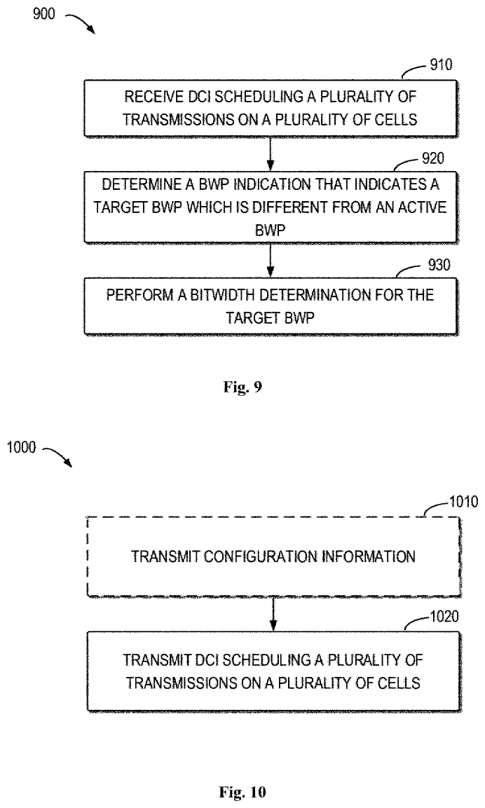

FIG. 10 shows a flowchart of an example method 1000 in accordance with an embodiment of the present disclosure. The method 1000 can be implemented at any suitable terminal devices. Only for the purpose of illustrations, the method 1000 can be implemented at a network device 120 as shown in FIG. 1.

In some embodiments, at block 1010, the network device 120 may transmit configuration information indicating indexes of the one or more BWPs to the terminal device 110. For example, each BWP defined for a numerology can have following three different parameters: subcarrier spacing, symbol duration and cyclic prefix length. In some embodiments, each DL BWP may comprise at least one control resource set (CORESET) with UE Specific Search Space (USS). Alternatively, at least one of the configured DL BWPs may comprise one CORESET with common search space (CSS). With respect to uplink, the terminal device 110 may not transmit PUSCH or PUCCH outside an active bandwidth part. There may be an initial active BWP for the terminal device 110 during the initial access until the terminal device 110 is explicitly configured with BWPs during or after RRC connection establishment. The term “initial BWP” used herein can refer to a BWP which is used to perform an initial access process. The term “active BWP” used herein can refer to a UE specific/dedicated BWP. The active BWP is the BWP which the terminal device uses for data transfer when the RRC connection is established. The term “default BWP” used herein can refer to a UE specific BWP which configured during RRC reconfiguration. If the default BWP is not configured, the initial BWP can be referred as the default BWP. For example, as shown in FIG. 2, the configuration information may include configurations of the BWPs 210-1, 210-2, 210-3 and 210-4 for the cell 101. Only as an example, the BWP 210-1 can be the initial BWP, the BWP 210-2 can be the active BWP and the BWP 210-4 can be the default BWP. The configuration information may also include the configurations of the BWPs 220-1 and 220-2.

In some example embodiments, the configuration information can be transmitted via RRC signaling. Alternatively, the configuration information can be transmitted via medium access control (MAC) signaling. In other embodiments, the configuration information may be transmitted via physical layer (PHY) signaling.

At block 1020, the network device 120 transmits, to the terminal device 110, downlink control information that schedules a plurality of transmissions on a plurality of cells. Each cell from the plurality of cells comprises one or more configured bandwidth parts (BWPs). The plurality of cells at least comprises a first cell and a second cell. If a bitdwidth of a first field of the active BWP for the first cell is larger than a bitdwidth of the first field of the target BWP and a bitwidth of a second field of the active BWP for the second cell is smaller than a bitwidth of the second field of the target BWP for the second cell, a portion of bits of the first field of the active BWP for the first cell and bits of the second field of the active BWP for the second cell are combined to indicate the second field of the target BWP for the second cell.

In some embodiments, if the second field of the active BWP of second cell is next to the first field of the active BWP of the first cell, the portion of bits comprises least significant bits of the first field of the active BWP for the first cell. In some embodiments, if the second field of the active BWP of second cell is before the first field of the active BWP of the first cell, the portion of bits comprises most significant bits of the first field of the active BWP for the first cell.

In some embodiments, the plurality of cells also comprises a third cell. In this case, in some embodiments, if a bitwidth of a third field of the active BWP for a third cell is larger than a bitwidth of the third field of the target BWP of the third cell, the combination of the portion of bits of the first field of the active BWP for the first cell and the bits of the second field of the active BWP for the second cell is smaller than the bitwidth of the second field of the target BWP for the second cell, a portion of bits of the third field of the active BWP for the third cell is also used to indicate the second field of the target BWP for the second cell.

In some embodiments, the portion of bits of the third field of the active BWP for the third cell comprises most significant bits of the third fields of the active BWP for the third cell.

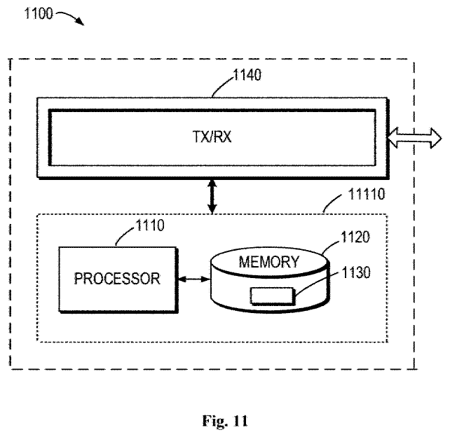

FIG. 11 is a simplified block diagram of a device 1100 that is suitable for implementing embodiments of the present disclosure. The device 1100 can be considered as a further example implementation of the terminal device 110 or the network device 120 as shown in FIG. 1. Accordingly, the device 1100 can be implemented at or as at least a part of the terminal device 110 or the network device 120.

As shown, the device 1100 includes a processor 1110, a memory 1120 coupled to the processor 1110, a suitable transmitter (TX)/receiver (RX) 1140 coupled to the processor 1110, and a communication interface coupled to the TX/RX 1140. The memory 1110 stores at least a part of a program 1130. The TX/RX 1140 is for bidirectional communications. The TX/RX 1140 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1130 is assumed to include program instructions that, when executed by the associated processor 1110, enable the device 1100 to operate in accordance with the embodiments of the present disclosure, as discussed herein with reference to FIGS. 1 to 10. The embodiments herein may be implemented by computer software executable by the processor 1110 of the device 1100, or by hardware, or by a combination of software and hardware. The processor 1110 may be configured to implement various embodiments of the present disclosure. Furthermore, a combination of the processor 1110 and memory 1120 may form processing means 1150 adapted to implement various embodiments of the present disclosure.

The memory 1120 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1120 is shown in the device 1100, there may be several physically distinct memory modules in the device 1100. The processor 1110 may be of any type suitable to the local technical network, and may include one or more of general purpose computers, special purpose computers, microprocessors, digital signal processors (DSPs) and processors based on multicore processor architecture, as non-limiting examples. The device 1100 may have multiple processors, such as an application specific integrated circuit chip that is slaved in time to a clock which synchronizes the main processor.

In some embodiments, a terminal device comprises a circuitry configured to: receive, from a network device, downlink control information that schedules a plurality of transmissions on a plurality of cells, wherein each cell from the plurality of cells comprises one or more configured bandwidth parts (BWPs); determine, from the downlink control information, a BWP indication for the plurality of cells; and in accordance with a determination that a value of the BWP indication is not within a set of values configured for a cell of the plurality of cells, cause the BWP indication to be ignored for the cell.

In some embodiments, a terminal device comprises a circuitry configured to: receive, from a network device, downlink control information that schedules a plurality of transmissions on a plurality of cells, wherein each cell from the plurality of cells comprises one or more configured bandwidth parts (BWPs), and wherein the plurality of cells at least comprises a first cell and a second cell; and determine, from the downlink control information, a BWP indication that indicates a target BWP which different from an active BWP for a cell, and wherein if a bitdwidth of a first field of the active BWP for the first cell is larger than a bitdwidth of the first field of the target BWP and a bitwidth of a second field of the active BWP for the second cell is smaller than a bitwidth of the second field of the target BWP for the second cell, a portion of bits of the first field of the active BWP for the first cell and bits of the second field of the active BWP for the second cell are combined to indicate the second field of the target BWP for the second cell.

In some embodiments, a terminal device comprises a circuitry configured to: receive, from a network device, downlink control information that schedules a plurality of transmissions on a plurality of cells, wherein each cell from the plurality of cells comprises one or more configured bandwidth parts (BWPs), and wherein the plurality of cells at least comprises a first cell and a second cell; determine, from the downlink control information, a BWP indication that indicates a target BWP which different from an active BWP for a cell; and perform, for each of the plurality of cells, a bitwidth determination for the target BWP.

In some embodiments, a network device comprises a circuitry configured to: transmit, to a terminal device, downlink control information that schedules a plurality of transmissions on a plurality of cells, wherein each cell from the plurality of cells comprises one or more configured bandwidth parts (BWPs), and wherein the plurality of cells at least comprises a first cell and a second cell, and wherein if a bitdwidth of a first field of the active BWP for the first cell is larger than a bitdwidth of the first field of the target BWP and a bitwidth of a second field of the active BWP for the second cell is smaller than a bitwidth of the second field of the target BWP for the second cell, a portion of bits of the first field of the active BWP for the first cell and bits of the second field of the active BWP for the second cell are combined to indicate the second field of the target BWP for the second cell.

According to embodiments of the present disclosure, the circuitry may be configured to perform any of the method implemented by the device as discussed above.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure provide the following solutions.

In an aspect, a terminal device, comprises a processor, configured to cause the terminal device to: receive, from a network device, downlink control information that schedules a plurality of transmissions on a plurality of cells, wherein each cell from the plurality of cells comprises one or more configured bandwidth parts (BWPs); determine, from the downlink control information, a BWP indication for the plurality of cells; and in accordance with a determination that a value of the BWP indication is not within a set of values configured for a cell of the plurality of cells, cause the BWP indication to be ignored for the cell.

In some solutions, the processor is configured to further cause the terminal device to cause the BWP indication to be ignored by: causing the BWP indication not to be applied; and causing switching to the BWP to be skipped.

In some solutions, the processor is configured to further cause the terminal device to: perform a modulo operation using the value of the BWP indication and a BWP value for the cell, and wherein the BWP value is equal to the number of BWPs configured for the cell excluding an initial BWP, or wherein the BWP value is equal to the number of BWPs configured for the cell excluding an initial BWP plus 1.

In some solutions, the processor is configured to further cause the terminal device to: determine a bitwidth of the BWP indication based on a maximum value of a BWP identity, and regardless of the number of BWPs configured for the cell, determine that the BWP indication is equivalent to the value of the BWP identity.

In an aspect, a terminal device, comprises a processor, configured to cause the terminal device to: receive, from a network device, downlink control information that schedules a plurality of transmissions on a plurality of cells, wherein each cell from the plurality of cells comprises one or more configured bandwidth parts (BWPs), and wherein the plurality of cells at least comprises a first cell and a second cell; and determine, from the downlink control information, a BWP indication that indicates a target BWP which different from an active BWP for a cell, and wherein if a bitdwidth of a first field of the active BWP for the first cell is larger than a bitdwidth of the first field of the target BWP and a bitwidth of a second field of the active BWP for the second cell is smaller than a bitwidth of the second field of the target BWP for the second cell, a portion of bits of the first field of the active BWP for the first cell and bits of the second field of the active BWP for the second cell are combined to indicate the second field of the target BWP for the second cell.

In some solutions, if the second field of the active BWP of second cell is next to the first field of the active BWP of the first cell, the portion of bits comprises least significant bits of the first field of the active BWP for the first cell.

In some solutions, if the second field of the active BWP of second cell is before the first field of the active BWP of the first cell, the portion of bits comprises most significant bits of the first field of the active BWP for the first cell.

In some solutions, the plurality of cells also comprises a third cell, and wherein if a bitwidth of a third field of the active BWP for a third cell is larger than a bitwidth of the third field of the target BWP of the third cell, the combination of the portion of bits of the first field of the active BWP for the first cell and the bits of the second field of the active BWP for the second cell is smaller than the bitwidth of the second field of the target BWP for the second cell, a portion of bits of the third field of the active BWP for the third cell is also used to indicate the second field of the target BWP for the second cell.

In some solutions, the portion of bits of the third field of the active BWP for the third cell comprises most significant bits of the third fields of the active BWP for the third cell.

In an aspect, a terminal device, comprises a processor, configured to cause the terminal device to: receive, from a network device, downlink control information that schedules a plurality of transmissions on a plurality of cells, wherein each cell from the plurality of cells comprises one or more configured bandwidth parts (BWPs), and wherein the plurality of cells at least comprises a first cell and a second cell; determine, from the downlink control information, a BWP indication that indicates a target BWP which different from an active BWP for a cell; and perform, for each of the plurality of cells, a bitwidth determination for the target BWP.

In some solutions, the processor is configured to further cause the terminal device to: in accordance with a determination that a bitwidth of the field of the active BWP of a target cell is smaller than the bitwidth of the field of the target BWP of the target cell, apply a predetermined resource allocation type for the target BWP of the target cell.

In some solutions, the processor is configured to further cause the terminal device to: in accordance with a determination that a value of codeword number for the target BWP of a target cell is larger than a value of codeword number for the active BWP of the target cell, cause a part of decoding information for the target BWP of the target cell to be ignored.

In an aspect, a network device, comprises a processor, configured to cause the network device to: transmit, to a terminal device, downlink control information that schedules a plurality of transmissions on a plurality of cells, wherein each cell from the plurality of cells comprises one or more configured bandwidth parts (BWPs), and wherein the plurality of cells at least comprises a first cell and a second cell, and wherein if a bitdwidth of a first field of the active BWP for the first cell is larger than a bitdwidth of the first field of the target BWP and a bitwidth of a second field of the active BWP for the second cell is smaller than a bitwidth of the second field of the target BWP for the second cell, a portion of bits of the first field of the active BWP for the first cell and bits of the second field of the active BWP for the second cell are combined to indicate the second field of the target BWP for the second cell.

In some solutions, if the second field of the active BWP of second cell is next to the first field of the active BWP of the first cell, the portion of bits comprises least significant bits of the first field of the active BWP for the first cell.

In some solutions, if the second field of the active BWP of second cell is before the first field of the active BWP of the first cell, the portion of bits comprises most significant bits of the first field of the active BWP for the first cell.

In some solutions, the plurality of cells also comprises a third cell, and wherein if a bitwidth of a third field of the active BWP for a third cell is larger than a bitwidth of the third field of the target BWP of the third cell, the combination of the portion of bits of the first field of the active BWP for the first cell and the bits of the second field of the active BWP for the second cell is smaller than the bitwidth of the second field of the target BWP for the second cell, a portion of bits of the third field of the active BWP for the third cell is also used to indicate the second field of the target BWP for the second cell.

In some solutions, the portion of bits of the third field of the active BWP for the third cell comprises most significant bits of the third fields of the active BWP for the third cell.

In an aspect, a computer readable medium having instructions stored thereon, the instructions, when executed on at least one processor, causing the at least one processor to perform the method implemented by the device discussed above.

In an aspect, a computer program comprising instructions, the instructions, when executed on at least one processor, causing the at least one processor to perform the method implemented by the device discussed above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 10. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-20. (canceled)

21. A method for communication comprising:
receiving, at a terminal device from a network device, downlink control information (DCI) that schedules a plurality of transmissions on a plurality of cells, wherein each cell from the plurality of cells comprises one or more configured bandwidth parts (BWPs); and
ignoring a value of the BWP indication for a scheduled cell in a case where the value does not correspond to a configured BWP of the scheduled cell.

22. The method of claim 21,
in response to ignoring a value of the BWP indication, operating on an active BWP of the scheduled cell.

23. The method of claim 21,
wherein a bitwidth of a BWP indication field in the DCI is determined based on a maximum number of BWPs configured across the plurality of cells.

24. A terminal device comprising:
one or more computer-readable memories having program instructions recorded therein;
one or more processors configured to execute the program instructions that when executed perform operations comprising:
receiving, at a terminal device from a network device, downlink control information (DCI) that schedules a plurality of transmissions on a plurality of cells, wherein each cell from the plurality of cells comprises one or more configured bandwidth parts (BWPs); and
ignoring a value of the BWP indication for a scheduled cell in a case where the value does not correspond to a configured BWP of the scheduled cell.

25. The terminal device of claim 24, further comprising:
in response to ignoring a value of the BWP indication, operating on an active BWP of the scheduled cell.

26. The terminal device of claim 24,
wherein a bitwidth of a BWP indication field in the DCI is determined based on a maximum number of BWPs configured across the plurality of cells.
